(19) United States
(12) Patent Application Publication
(10) Pub. No.: US 2013/0222187 A1
(43) Pub. Date: Aug. 29, 2013

(54) ANTENNA MODULE

(71) Applicants: CHING-WEI CHANG, NEW TAIPEI CITY (TW); YU TSUNG HUANG, KAOHSIUNG CITY (TW); JHE MIN LIN, TAOYUAN COUNTY (TW)

(72) Inventors: CHING-WEI CHANG, NEW TAIPEI CITY (TW); YU TSUNG HUANG, KAOHSIUNG CITY (TW); JHE MIN LIN, TAOYUAN COUNTY (TW)

(73) Assignee: AUDEN TECHNO CORP., TAOYUAN COUNTY (TW)

(21) Appl. No.: 13/402,959

(22) Filed: Feb. 23, 2012

(51) Int. Cl. H01Q 1/38; B82Y 10/00

(52) U.S. Cl. 343/700 MS; 977/773; 977/950

(57) ABSTRACT

An antenna module capable includes a substrate unit and an antenna unit. The substrate unit includes at least one carrier substrate having a dielectric constant substantially between 7 and 13. The carrier substrate includes a dielectric body and a plurality of nano-scale microparticle structures distributed inside the dielectric body, and each nano-scale microparticle structure includes at least one nano-scale carbon particle and a nano-scale insulating encapsulation layer for totally encapsulating the nano-scale carbon particle. The antenna unit includes at least one antenna track disposed on the carrier substrate. The antenna track has an antenna usage volume that is adjustable within a predetermined volume range according to the VSWR value and the antenna efficiency maintained within a first and a second predetermined ranges, and the antenna track has at least one feeding portion and at least one grounding portion.

### BACKGROUND OF THE INVENTION

1. Field of the Invention

The instant disclosure relates to an antenna module, and more particularly, to an antenna module capable of respectively maintaining the VSWR value and the antenna efficiency within a first and a second predetermined ranges when the antenna usage volume been reduced within a predetermined reduction range.

2. Description of Related Art

With the development of wireless communication technologies, wireless transmission technologies are widely used in mobile information media or personal data management tools. For example, electronic products, such as notebook computers and so on, usually need to transmit/receive data to/from other data devices. Based on wireless transmission technologies, many structures can be simplifies and many connecting wires can be avoided. To achieve the above-mentioned wireless transmission, conventional electronic products must have antennae, and most of the electronic products have inbuilt antenna devices for wireless communication.

### SUMMARY OF THE INVENTION

One aspect of the instant disclosure relates to an antenna module capable of respectively maintaining the VSWR value and the antenna efficiency within a first and a second predetermined ranges when the antenna usage volume been reduced within a predetermined reduction range.

One of the embodiments of the instant disclosure provides an antenna module capable, comprising: a substrate unit and an antenna unit. The substrate unit includes at least one carrier substrate, wherein the at least one carrier substrate has a dielectric constant substantially between 7 and 13 according to the VSWR value and the antenna efficiency within the first and the second predetermined ranges, the at least one carrier substrate includes a dielectric body and a plurality of nano-scale microparticle structures distributed inside the dielectric body, and each nano-scale microparticle structure includes at least one nano-scale carbon particle and a nano-scale insulating encapsulation layer for totally encapsulating the at least one nano-scale carbon particle. The antenna unit includes at least one antenna track disposed on the at least one carrier substrate, wherein the at least one antenna track has an antenna usage volume that is adjustable within a predetermined volume range according to the VSWR value and the antenna efficiency maintained within the first and the second predetermined ranges, and the antenna track has at least one feeding portion and at least one grounding portion.

Another one of the embodiments of the instant disclosure provides an antenna module capable, comprising: a substrate unit and an antenna unit. The substrate unit includes at least one carrier substrate, wherein the at least one carrier substrate has a dielectric constant substantially between 7 and 13 according to the VSWR value and the antenna efficiency within the first and the second predetermined ranges, the at least one carrier substrate includes a dielectric body, a plurality of first nano-scale microparticle structures distributed inside the dielectric body, and a plurality of second nano-scale microparticle structures distributed inside the dielectric body, wherein each first nano-scale microparticle structure includes at least one first nano-scale carbon particle and a first nano-scale insulating encapsulation layer for totally encapsulating the at least one first nano-scale carbon particle, and each second nano-scale microparticle structure includes at least one second nano-scale carbon particle and a second nano-scale insulating encapsulation layer for totally encapsulating the at least one second nano-scale carbon particle. The antenna unit includes at least one antenna track disposed on the at least one carrier substrate, wherein the at least one antenna track has an antenna usage volume that is adjustable within a predetermined volume range according to the VSWR value and the antenna efficiency maintained within the first and the second predetermined ranges, and the antenna track has at least one feeding portion and at least one grounding portion.

Therefore, the nano-scale microparticle structures are distributed inside the dielectric body or the first and the second nano-scale microparticle structures distributed inside the dielectric body, thus when the antenna usage volume of the instant disclosure is reduced within the predetermined reduction range, the antenna module can be used to respectively maintain the VSWR value and the antenna efficiency within the first and the second predetermined ranges.

To further understand the techniques, means and effects of the instant disclosure applied for achieving the prescribed objectives, the following detailed descriptions and appended drawings are hereby referred, such that, through which, the purposes, features and aspects of the instant disclosure can be thoroughly and concretely appreciated. However, the appended drawings are provided solely for reference and illustration, without any intention to limit the instant disclosure.

### BRIEF DESCRIPTION OF THE DRAWINGS

FIG. 1A shows a top, schematic view of the original antenna module according to the first embodiment of the instant disclosure;

FIG. 1B shows a partial, cross-sectional, schematic view of the antenna module according to the first embodiment of the instant disclosure;

FIG. 1C shows a top, schematic view of the reduced antenna module according to the first embodiment of the instant disclosure;

FIG. 1D shows a graph of comparing the VSWR value of the original antenna module with the VSWR value of the reduced antenna module according to the first embodiment of the instant disclosure;

FIG. 1E shows a graph of comparing the antenna efficiency of the original antenna module with the antenna efficiency of the reduced antenna module according to the first embodiment of the instant disclosure;

FIG. 2 shows a partial, cross-sectional, schematic view of the antenna module according to the second embodiment of the instant disclosure;

FIG. 3 shows a partial, cross-sectional, schematic view of the antenna module according to the third embodiment of the instant disclosure; and

FIG. 4 shows a partial, cross-sectional, schematic view of the antenna module according to the fourth embodiment of the instant disclosure.

### DETAILED DESCRIPTION OF THE PREFERRED EMBODIMENTS

### First Embodiment

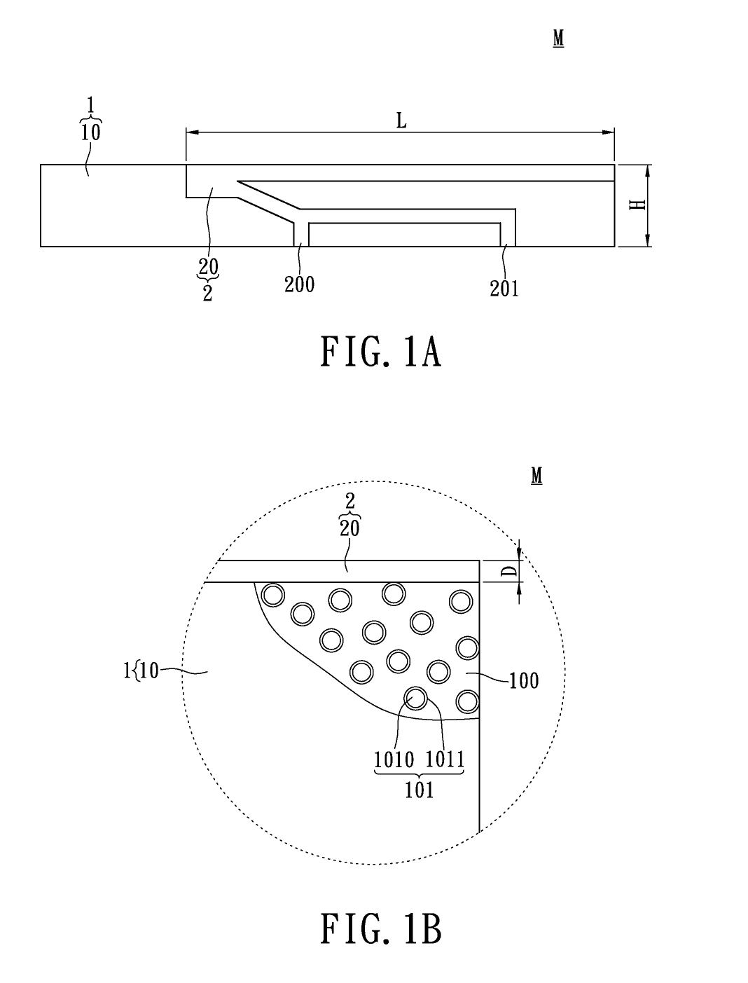

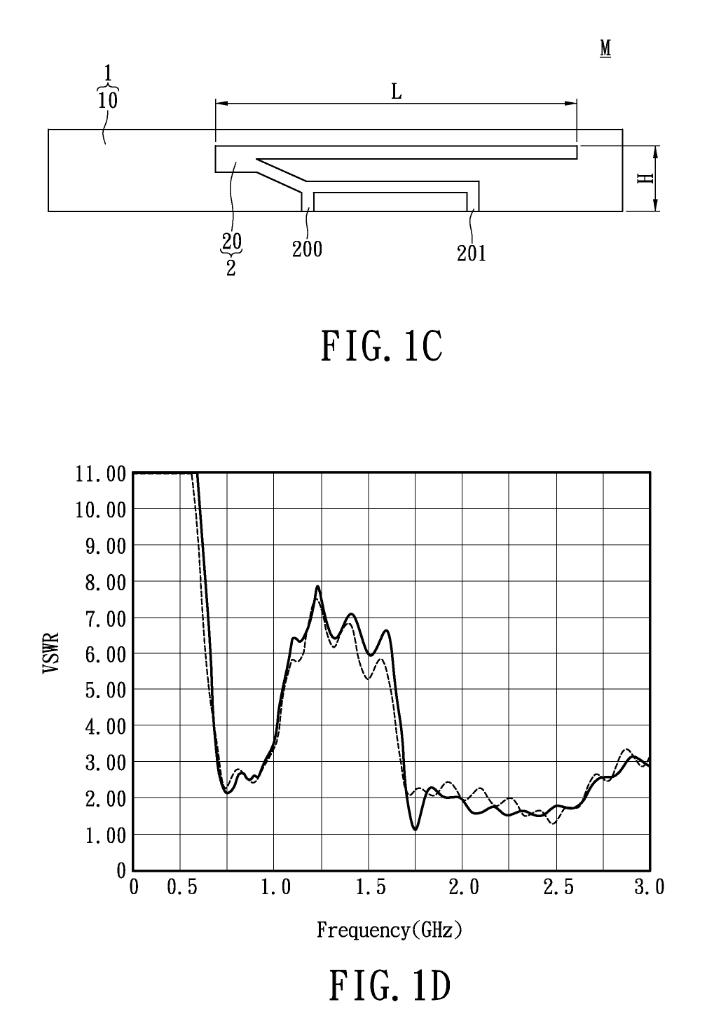

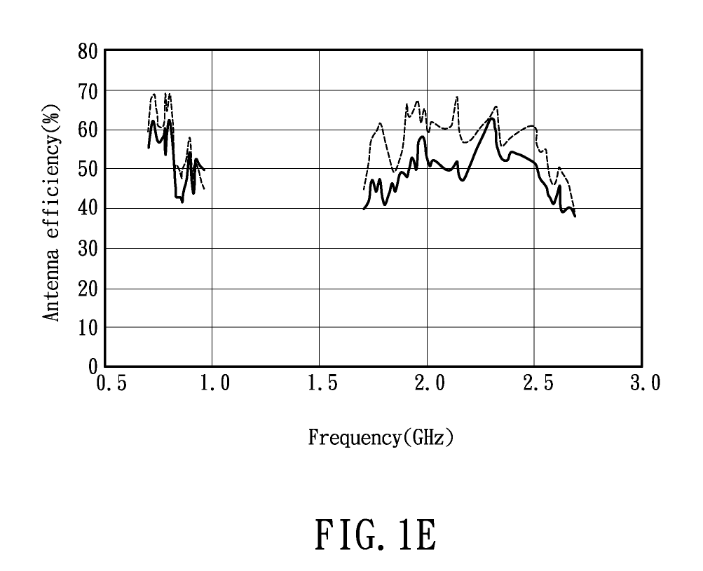

Referring to FIG. 1A to FIG. 1E, where the first embodiment of the instant disclosure provides an antenna module M comprising a substrate unit 1 and an antenna unit 2. When the antenna usage volume is reduced within a predetermined reduction range, the antenna module M is capable of respectively maintaining the VSWR value and the antenna efficiency within a first predetermined range and a second predetermined range. The antenna module M.

Referring to FIG. 1A and FIG. 1B, the substrate unit 1 includes at least one carrier substrate 10. The carrier substrate 10 has a dielectric constant substantially between 7 and 13 according to the VSWR value and the antenna efficiency within the first and the second predetermined ranges, where the better dielectric constant is close to 10. In addition, the carrier substrate 10 includes a dielectric body 100 and a plurality of nano-scale microparticle structures 101 distributed inside the dielectric body 100, and each nano-scale microparticle structure 101 includes at least one nano-scale carbon particle 1010 and a nano-scale insulating encapsulation layer 1011 for totally encapsulating the nano-scale carbon particle 1010. For example, the carrier substrate 10 may be a microwave substrate. The nano-scale microparticle structures 101 can be separated from each other and averagely distributed inside the dielectric body 100. Most of the nano-scale microparticle structures 101 are totally received inside the dielectric body 100, and one part of each of the other nano-scale microparticle structures 101 may be exposed from the dielectric body 100. Of course, the nano-scale microparticle structures 101 also can be unaveragely or unequally distributed inside the dielectric body 100. However, the nano-scale microparticle structure 101 used in the first embodiment is merely an example and is not meant to limit the instant disclosure.

Referring to FIG. 1A and FIG. 1B, the antenna unit 2 includes at least one antenna track 20 disposed on the carrier substrate 10, where the antenna track 20 has an antenna usage volume that is adjustable or can be adjusted within a predetermined volume range according to the VSWR value and the antenna efficiency maintained within the first and the second predetermined ranges, and the antenna track 20 has at least one feeding portion 200 and at least one grounding portion 201. In addition, the antenna track 20 has an antenna length L that is adjustable or can be adjusted within a predetermined length range according to the VSWR value and the antenna efficiency maintained within the first and the second predetermined ranges, an antenna height H that is adjustable or can be adjusted within a predetermined height range according to the VSWR value and the antenna efficiency maintained within the first and the second predetermined ranges, and an antenna thickness D that is substantially uniform. The antenna length L can be extended from the leftmost side of the antenna track 20 to the rightmost side of the antenna track 20, the antenna height H can be extended from the topmost side of the antenna track 20 to the bottommost side of the antenna track 20, and the antenna length L multiplied by the antenna height H and the antenna thickness D are equal to the antenna usage volume of the antenna track 20.

For example, before the antenna usage volume of the antenna track 20 is reduced (as shown in FIG. 1A), the antenna length L is 70 mm, the antenna height H is 10 mm and the antenna thickness D is 3 mm, thus the original antenna usage volume of the antenna track 20 can be shown as 70 mm×10 mm×3 mm=2100 mm³ and the antenna track 20 can obtain perfect VSWR value (shown as the solid line in FIG. 1D) and perfect antenna efficiency (shown as the solid line in FIG. 1E). After the antenna usage volume of the antenna track 20 is reduced (as shown in FIG. 1C), the antenna length L is reduced to 65 mm, the antenna height H is reduced to 8 mm and the antenna thickness D is kept in 3 mm, thus the reduced antenna usage volume of the antenna track 20 can be shown as 65 mm×8 mm×3 mm=1560 mm³. Although the original antenna usage volume of the antenna track 20 is reduced by 25%, the VSWR value (shown as the broken line in FIG. 1D) and the antenna efficiency (shown as the broken line in FIG. 1E) also can be kept within a good range.

Hence, although the original antenna usage volume of the antenna track 20 is reduced within a predetermined reduced percentage (such as 1% to 25%), the antenna module M is capable of respectively maintaining the VSWR value and the antenna efficiency within a first predetermined good range and a second predetermined good range due to the design of the carrier substrate 10 having the dielectric constant substantially between 7 and 13.

### Second Embodiment

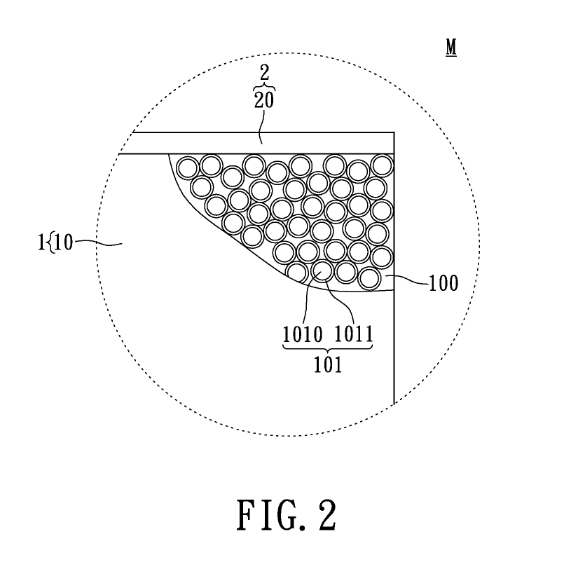

Referring to FIG. 2, where the second embodiment of the instant disclosure provides an antenna module M capable of respectively maintaining the VSWR value and the antenna efficiency within a first and a second predetermined ranges when the antenna usage volume been reduced within a predetermined reduction range, comprising a substrate unit 1 and an antenna unit 2. Comparing FIG. 2 with FIG. 1B, the difference between the second embodiment and the first embodiment is as follows: in the second embodiment, the nano-scale microparticle structures 101 can be abutted against each other and averagely distributed inside the dielectric body 100. Of course, the nano-scale microparticle structures 101 also can be unaveragely or unequally distributed inside the dielectric body 100.

However, the nano-scale microparticle structure 101 used in the second embodiment is merely an example and is not meant to limit the instant disclosure. For example, with regard to the arrangement of the nano-scale microparticle structures 101, some of the nano-scale microparticle structures 101 can be separated from each other and averagely distributed inside the dielectric body 100, and the other nano-scale microparticle structures 101 can be abutted against each other and averagely distributed inside the dielectric body 100.

### Third Embodiment

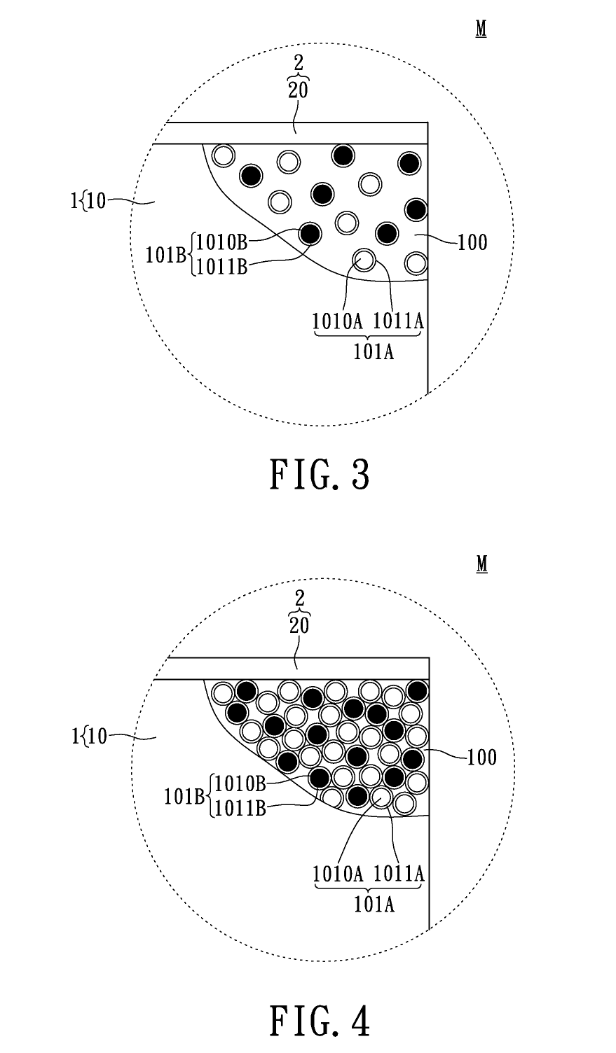

Referring to FIG. 3, where the third embodiment of the instant disclosure provides an antenna module M capable of respectively maintaining the VSWR value and the antenna efficiency within a first and a second predetermined ranges when the antenna usage volume been reduced within a predetermined reduction range, comprising a substrate unit 1 and an antenna unit 2. Comparing FIG. 3 with FIG. 1B, the difference between the third embodiment and the first embodiment is as follows: in the third embodiment, the carrier substrate 10 includes a dielectric body 100, a plurality of first nano-scale microparticle structures 101A distributed inside the dielectric body 100, and a plurality of second nano-scale microparticle structures 101B distributed inside the dielectric body 100. Each first nano-scale microparticle structure 101A includes at least one first nano-scale carbon particle 1010A and a first nano-scale insulating encapsulation layer 1011A for totally encapsulating the first nano-scale carbon particle 1010A, and each second nano-scale microparticle structure 101B includes at least one second nano-scale carbon particle 1010B and a second nano-scale insulating encapsulation layer 1011B for totally encapsulating the second nano-scale carbon particle 1010B. Hence, the carrier substrate 10 having the dielectric constant substantially between 7 and 13 can be manufactured by using more than two types of nano-scale microparticle structures.

For example, the first nano-scale microparticle structures 101A can be separated from each other and averagely distributed inside the dielectric body 100, and the second nano-scale microparticle structures 101B can be separated from each other and averagely distributed inside the dielectric body 100. Of course, the first nano-scale microparticle structures 101A and the second nano-scale microparticle structures 101B also can be unaveragely or unequally distributed inside the dielectric body 100. However, the first nano-scale microparticle structure 101A or the second nano-scale microparticle structure 101B used in the third embodiment is merely an example and is not meant to limit the instant disclosure.

### Fourth Embodiment

Referring to FIG. 4, where the fourth embodiment of the instant disclosure provides an antenna module M capable of respectively maintaining the VSWR value and the antenna efficiency within a first and a second predetermined ranges when the antenna usage volume been reduced within a predetermined reduction range, comprising a substrate unit 1 and an antenna unit 2. Comparing FIG. 4 with FIG. 3, the difference between the fourth embodiment and the third embodiment is as follows: in the fourth embodiment, the first nano-scale microparticle structures 101A are abutted against each other and averagely distributed inside the dielectric body, and the second nano-scale microparticle structures 101B are abutted against each other and averagely distributed inside the dielectric body. Of course, the first nano-scale microparticle structures 101A and the second nano-scale microparticle structures 101B also can be unaveragely or unequally distributed inside the dielectric body 100.

However, the first nano-scale microparticle structure 101A or the second nano-scale microparticle structure 101B used in the fourth embodiment is merely an example and is not meant to limit the instant disclosure. For example, with regard to the arrangement of the first nano-scale microparticle structures 101A, some of the first nano-scale microparticle structures 101A are separated from each other and averagely distributed inside the dielectric body 100, and the other first nano-scale microparticle structures 101A are abutted against each other and averagely distributed inside the dielectric body 100. With regard to the arrangement of the second nano-scale microparticle structures 101B, some of the second nano-scale microparticle structures 101B are separated from each other and averagely distributed inside the dielectric body 100, and the other second nano-scale microparticle structures 101B are abutted against each other and averagely distributed inside the dielectric body 100.

In conclusion, the nano-scale microparticle structures are distributed inside the dielectric body or the first and the second nano-scale microparticle structures distributed inside the dielectric body, thus when the antenna usage volume of the instant disclosure is reduced within the predetermined reduction range, the antenna module can be used to respectively maintain the VSWR value and the antenna efficiency within the first and the second predetermined ranges.

The above-mentioned descriptions merely represent the preferred embodiments of the instant disclosure, without any intention or ability to limit the scope of the instant disclosure which is fully described only within the following claims Various equivalent changes, alterations or modifications based on the claims of instant disclosure are all, consequently, viewed as being embraced by the scope of the instant disclosure.

What is claimed is:

1. An antenna module capable of respectively maintaining the VSWR value and the antenna efficiency within a first and a second predetermined ranges when the antenna usage volume been reduced within a predetermined reduction range, comprising:
a substrate unit including at least one carrier substrate, wherein the at least one carrier substrate has a dielectric constant substantially between 7 and 13 according to the VSWR value and the antenna efficiency within the first and the second predetermined ranges, the at least one carrier substrate includes a dielectric body and a plurality of nano-scale microparticle structures distributed inside the dielectric body, and each nano-scale microparticle structure includes at least one nano-scale carbon particle and a nano-scale insulating encapsulation layer for totally encapsulating the at least one nano-scale carbon particle; and
an antenna unit including at least one antenna track disposed on the at least one carrier substrate, wherein the at least one antenna track has an antenna usage volume that is adjustable within a predetermined volume range according to the VSWR value and the antenna efficiency maintained within the first and the second predetermined ranges, and the antenna track has at least one feeding portion and at least one grounding portion.

2. The antenna module of claim 1, wherein the nano-scale microparticle structures are separated from each other and averagely distributed inside the dielectric body.

3. The antenna module of claim 1, wherein the nano-scale microparticle structures are abutted against each other and averagely distributed inside the dielectric body.

4. The antenna module of claim 1, wherein some of the nano-scale microparticle structures are separated from each other and averagely distributed inside the dielectric body, and the other nano-scale microparticle structures are abutted against each other and averagely distributed inside the dielectric body.

5. The antenna module of claim 1, wherein the at least one antenna track has an antenna length that is adjustable within a predetermined length range according to the VSWR value and the antenna efficiency maintained within the first and the second predetermined ranges, an antenna height that is adjustable within a predetermined height range according to the VSWR value and the antenna efficiency maintained within the first and the second predetermined ranges, and an antenna thickness that is uniform, the antenna length is extended from the leftmost side of the at least one antenna track to the rightmost side of the at least one antenna track, the antenna height is extended from the topmost side of the at least one antenna track to the bottommost side of the at least one antenna track, and the antenna length multiplied by the antenna height and the antenna thickness are equal to the antenna usage volume of the at least one antenna track.

6. An antenna module capable of respectively maintaining the VSWR value and the antenna efficiency within a first and a second predetermined ranges when the antenna usage volume been reduced within a predetermined reduction range, comprising:
a substrate unit including at least one carrier substrate, wherein the at least one carrier substrate has a dielectric constant substantially between 7 and 13 according to the VSWR value and the antenna efficiency within the first and the second predetermined ranges, the at least one carrier substrate includes a dielectric body, a plurality of first nano-scale microparticle structures distributed inside the dielectric body, and a plurality of second nano-scale microparticle structures distributed inside the dielectric body, wherein each first nano-scale microparticle structure includes at least one first nano-scale carbon particle and a first nano-scale insulating encapsulation layer for totally encapsulating the at least one first nano-scale carbon particle, and each second nano-scale microparticle structure includes at least one second nano-scale carbon particle and a second nano-scale insulating encapsulation layer for totally encapsulating the at least one second nano-scale carbon particle; and
an antenna unit including at least one antenna track disposed on the at least one carrier substrate, wherein the at least one antenna track has an antenna usage volume that is adjustable within a predetermined volume range according to the VSWR value and the antenna efficiency maintained within the first and the second predetermined ranges, and the antenna track has at least one feeding portion and at least one grounding portion.

7. The antenna module of claim 6, wherein the first nano-scale microparticle structures are separated from each other and averagely distributed inside the dielectric body, and the second nano-scale microparticle structures are separated from each other and averagely distributed inside the dielectric body.

8. The antenna module of claim 6, wherein the first nano-scale microparticle structures are abutted against each other and averagely distributed inside the dielectric body, and the second nano-scale microparticle structures are abutted against each other and averagely distributed inside the dielectric body.

9. The antenna module of claim 6, wherein some of the first nano-scale microparticle structures are separated from each other and averagely distributed inside the dielectric body, and the other first nano-scale microparticle structures are abutted against each other and averagely distributed inside the dielectric body, wherein some of the second nano-scale microparticle structures are separated from each other and averagely distributed inside the dielectric body, and the other second nano-scale microparticle structures are abutted against each other and averagely distributed inside the dielectric body.

10. The antenna module of claim 6, wherein the at least one antenna track has an antenna length that is adjustable within a predetermined length range according to the VSWR value and the antenna efficiency maintained within the first and the second predetermined ranges, an antenna height that is adjustable within a predetermined height range according to the VSWR value and the antenna efficiency maintained within the first and the second predetermined ranges, and an antenna thickness that is uniform, the antenna length is extended from the leftmost side of the at least one antenna track to the rightmost side of the at least one antenna track, the antenna height is extended from the topmost side of the at least one antenna track to the bottommost side of the at least one antenna track, and the antenna length multiplied by the antenna height and the antenna thickness are equal to the antenna usage volume of the at least one antenna track.
